(19) United States
(12) Patent Application Publication
(10) Pub. No.: US 2015/0149215 A1
(43) Pub. Date: May 28, 2015

(54) SYSTEM AND METHOD TO DETECT AND VISUALIZE FINDING-SPECIFIC SUGGESTIONS AND PERTINENT PATIENT INFORMATION IN RADIOLOGY WORKFLOW

(71) Applicant: KONINKLIJKE PHILIPS N.V., Eindhoven (NL)

(72) Inventors: Yuechen Qian, Briarcliff Manor, NY (US); Merlijn Sevenster, New York, NY (US); Paul Joseph Chang, Chicago, IL (US)

(21) Appl. No.: 14/551,167

(22) Filed: Nov. 24, 2014

Related U.S. Application Data
(60) Provisional application No. 61/908,826, filed on Nov. 26, 2013.

(51) Int. Cl. G06F 19/00; G06F 3/0484; G06F 17/30

(52) U.S. Cl. CPC G06F 19/345; G06F 19/321; G06F 19/322; G06F 17/30011; G06F 3/04842
USPC 705/3

(57) ABSTRACT

A system for detecting and visualizing finding-specific suggestion and information includes a clinical database storing one or more clinical documents including clinical data. A natural language processing engine processes the clinical documents to detect clinical data pertinent to a patient. A context extraction and classification engine extracts clinical findings from the clinical data and detects finding-specific suggestions from the clinical findings. A clinical interface engine generates a user interface which enables the user to view the detected clinical data and finding-specific suggestions.

The present application relates generally to detecting and visualizing pertinent patient information and finding-specific suggestions in radiology workflow. It finds particular application in conjunction with providing patient context information based on the relevance and certainty of the information and will be described with particular reference there. It also finds particular application in conjunction with providing finding-specific suggestions made by previous radiologists and relevant pertinent evidences and will be described with particular reference thereto. However, it is to be understood that it also finds application in other usage scenarios and is not necessarily limited to the aforementioned application.

On a routine basis, radiologists have to work with an increasing number of images to diagnose patients in an optimal manner. Patients, especially those with cancers, frequently undergo imaging exams and over time accumulate many studies in their medical records. Each time a new study needs to be read, the radiologist typically opens the current imaging order to understand the clinical context and why the study has been performed.

Ideally, the radiologist should understand the outcome of relevant prior (imaging/lab) tests of the patient to best evaluate the disease and its progression over time. Because of time pressure, it's unlikely that the radiologist would review prior clinical data in the workflow. Instead, the radiologist typically uses the background information and reason for exam that are entered by the referring physician. This information is often very generic and succinct (e.g. “abd pain”). It is generally acknowledged that this reduces the radiologist's interpretation accuracy and consequently the total value of the imaging study.

Further, in clinical workflows, clinicians need to access and interpret pertinent clinical information about the patient to make appropriate diagnosis and recommendations, which is time-consuming to do. In the first instance, clinicians need to aggregate the clinical information in the medical record, study by study. In the second instance, the information relied upon to make diagnosis needs to be certain and relevant. Any clinical record of the patient may contain clinical information with varying levels of certainty and relevance that are determined by many factors including record type, age of the record, and correlation with other records. Many informatics solutions that support report searching and summarization present snippets of clinical information. However, they do not allow for fine-grained sorting and customization of the clinical information based on relevance/certainty.

Additionally, clinical information provided to the radiologist before he/she interprets an image needs to have relevance and high certainty. These two attributes—relevance and certainty—are dependent on the context in which the clinical information appears. For example, high certainty and high relevance information may include a diagnosis of prostate cancer in a pathology report. Whereas high certainty and low relevance information may include a condition of fever and cough reported in the clinical information section of a two-year old radiology report or a lower arm fracture reported ten years ago in an adolescent. High relevance and low certainty information may include a differential diagnosis of a rare type of cancer raised in a radiology report. Low relevance and low certainty information may include a possibility of cancer raised by a referring physician when ordering an exam five years ago.

From these examples, it becomes clear that certainty and relevance depends on several factors. One factor is the nature of the document in which information item appears.

For example, pathology generally trumps radiology, lab is ground truth but is readily outdated, and the like. Another factor is the narrative context in which it appears. For example, the certainty of the information item “prostate cancer” is different in each of the different narrative contexts such as “evaluate for prostate cancer,” “possibility of prostate cancer is raised,” and “pathologically confirmed history of prostate cancer.” Another factor is the clinical nature of evidence. Diagnoses are generally more relevant than symptoms. The temporality of the information is also important. The relevance and certainty of clinical information generally decreases as they were reported in the more distant past.

Because of the limited time to find all relevant clinical information, it would advantageous to have a system that can present the relevant patient context information upfront and indicate the certainty (“fidelity”) and relevance of the presented information. Radiology reports, lab reports, pathology reports, and electronic medical record (EMR) data of the patient are often unstructured or semi-structured medical documents that describe findings and diagnosis in natural language and also inherently difficult to process by the computer.

In the case of follow-up exams, radiologists often need to know whether the patient has prior lesions that need special attention. For example, the following sentences from previous reports of the patient contain finding specific suggestions: “1.2-cm right renal hypodensity is indeterminate, but stable, continued follow up is recommended”; “attention to this region on future follow-up exams can be made to assess for resolution”; “soft tissue fullness of the right hilum, similar to prior examinations but increased from 2009; and continued follow-up recommended to exclude indolent primary neoplasm”.

To locate finding-specific suggestions in prior reports, radiologists have to review prior radiology images and reports, which is very time-consuming Radiology reports are often unstructured medical documents that describe findings and diagnosis in natural language and thus inherently difficult to process by the computer. It would be advantageous to have a system that processes the prior reports of the patient, detects finding-specific suggestions and presents that information upfront before interpretation.

The present application provides a system and method which utilizes natural language processing and pattern recognition to present patient context information, indicate the certainty/fidelity and relevance of the information, detect and visualize finding-specific suggestions and allow radiologists to navigate the pertinent evidences, increasing workflow efficiency.

The present application also provides new and improved methods and systems which overcome the above-referenced problems and others.

In accordance with one aspect, a system for detecting and visualizing pertinent information is provided. The system includes a clinical database which stores one or more clinical documents including clinical data. A natural language processing engine processes the clinical documents to detected clinical data pertinent to a patient. A context extraction and classification engine extracts clinical findings from the clinical data and detects the certainty and relevance of the clinical findings. A clinical interface engine generates a user interface which enables the user to view the detected pertinent findings with certainty and relevance.

In accordance with another aspect, a system for detecting and visualizing finding-specific suggestion and information is provided. The system including one or more processors programmed to store one or more clinical documents including clinical data, process the clinical documents to detected clinical data pertinent to a patient, extract clinical findings from the clinical data and detects finding-specific suggestions from the clinical findings, and generate a user interface which enables the user to view the detected finding-specific suggestions.

In accordance with another aspect, a method for detecting and visualizing pertinent patient information is provided. The system including storing one or more clinical documents including clinical data, processing the clinical documents to detected clinical data pertinent to a patient, extracting clinical findings from the clinical data and detects the certainty and relevance of the clinical finding, and generating a user interface which enables the user to view the detected pertinent findings with certainty and relevance.

In accordance with another aspect, a method for detecting and visualizing finding-specific suggestion and information is provided. The method including storing one or more clinical documents including clinical data, processing the clinical documents to detected clinical data pertinent to a patient, extracting clinical findings from the clinical data and detects finding-specific suggestions from the clinical findings, and generating a user interface which enables the user to view the detected finding-specific suggestions.

One advantage resides in utilizing pattern recognition to detect and visualize patient context information and indicating the certainty/fidelity and relevance of that information

Another advantage resides in detecting and visualizing finding-specific suggestions.

Another advantage resides in enabling navigation of pertinent evidences relating to the extracted content information and finding-specific suggestions.

Another advantage resides in improved clinical workflow. Another advantage resides in improved patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

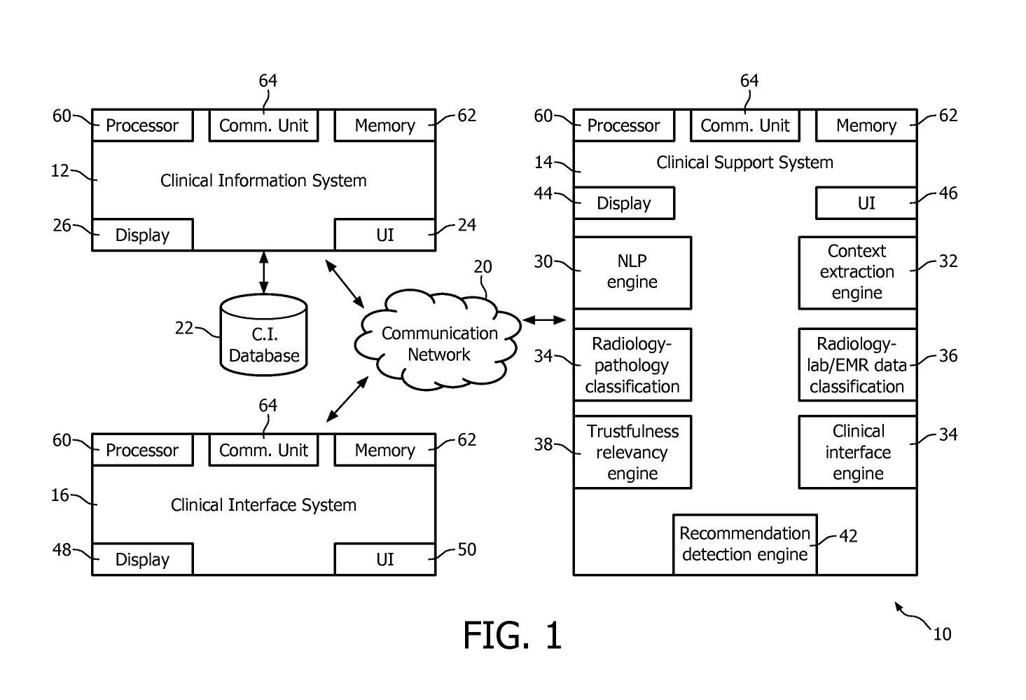

FIG. 1 illustrates a block diagram of an IT infrastructure of a medical institution according to aspects of the present application.

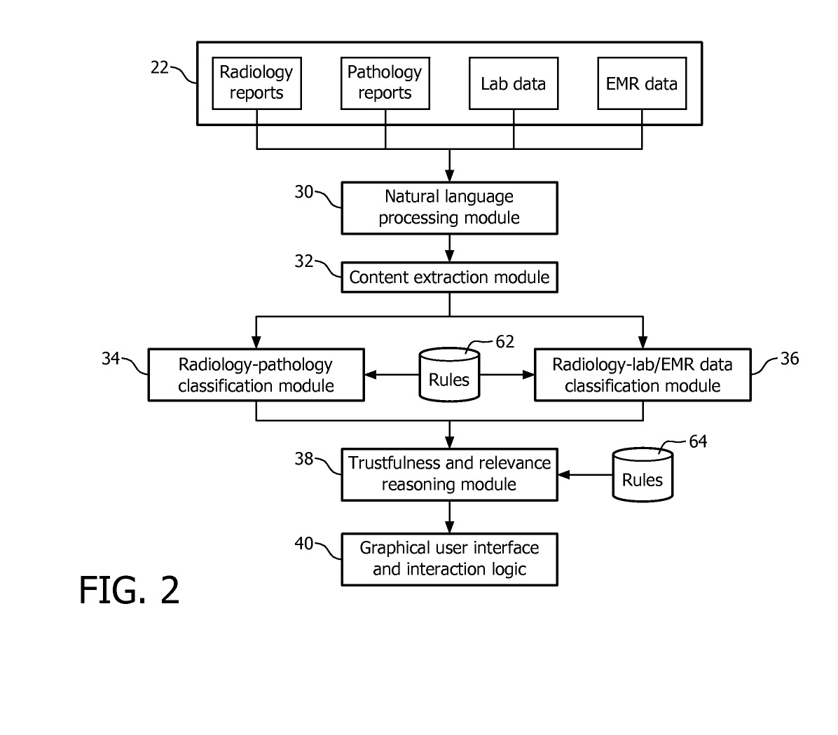

FIG. 2 illustrates a flowchart diagram of the operation of the IT infrastructure according to aspects of the present application.

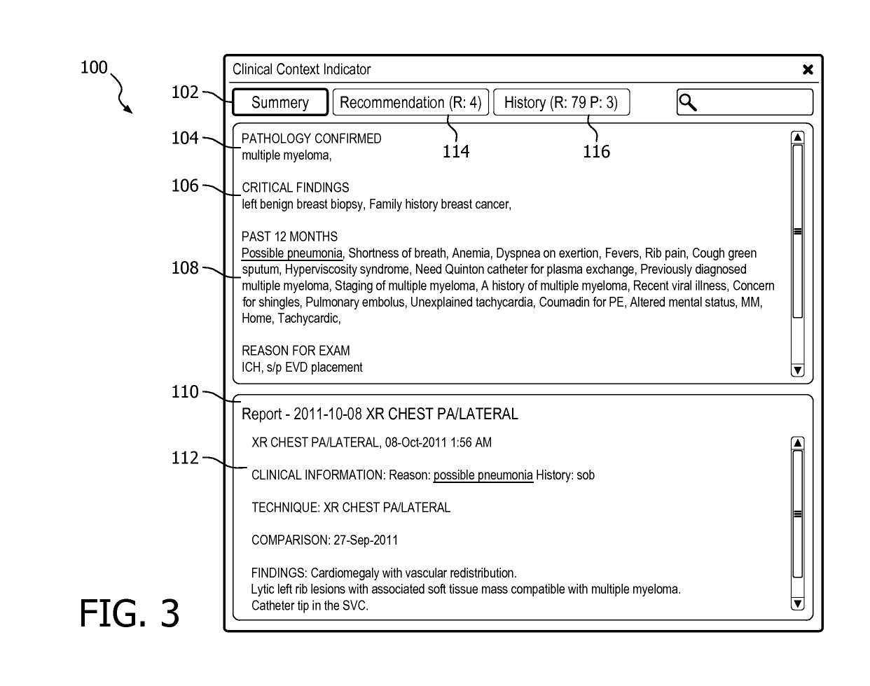

FIG. 3 illustrates an exemplary embodiment of clinical context interface generated by a clinical support system according to aspects of the present application.

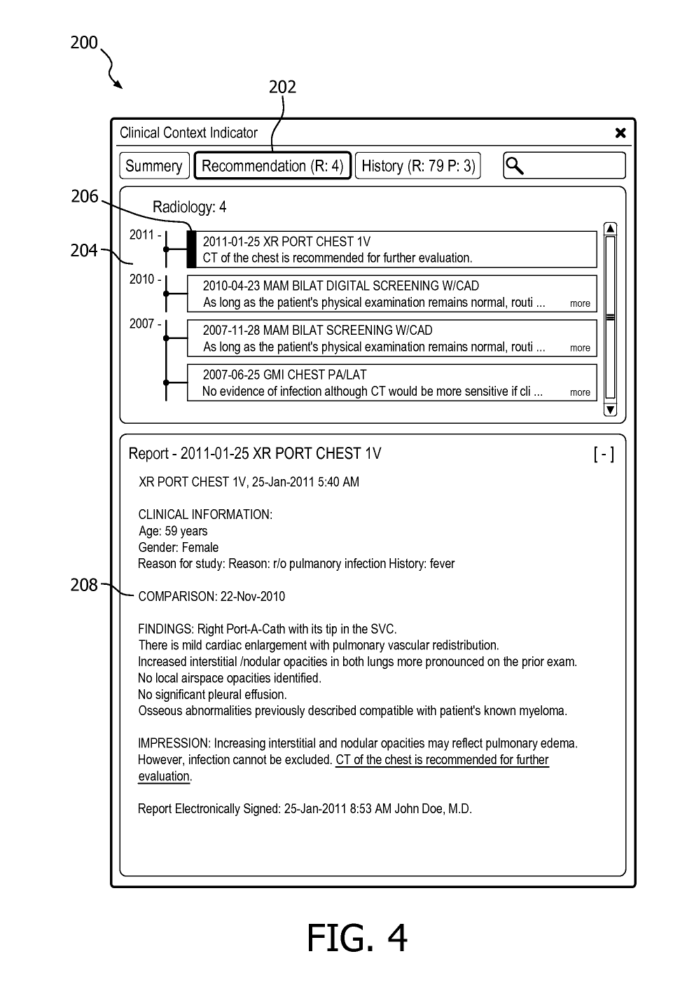

FIG. 4 illustrates another exemplary embodiment of clinical context interface generated by a clinical support system according to aspects of the present application.

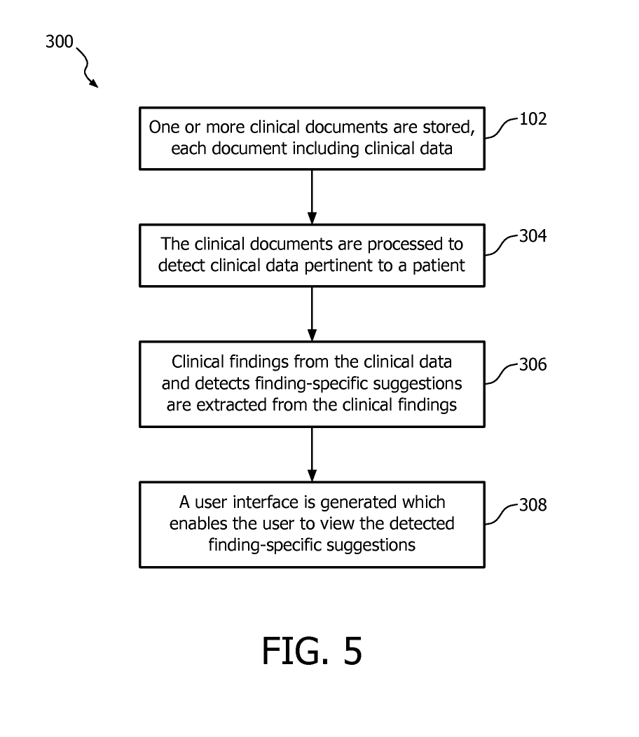

FIG. 5 illustrates a flowchart diagram of a method for detecting and visualizing finding-specific suggestions and patient information according to aspects of the present application.

With reference to FIG. 1, a block diagram illustrates one embodiment of an IT infrastructure 10 of a medical institution, such as a hospital. The IT infrastructure 10 suitably includes a clinical information system 12, a clinical support system 14, a clinical interface system 16, and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the IT infrastructure be located at a central location or at multiple remote locations.

The clinical information system 12 stores clinical documents including radiology reports, pathology reports, lab reports, lab/imaging reports, electronic health records, EMR data, and the like in a clinical information database 22. A clinical document may comprise documents with information relating to an entity, such as a patient. Some of the clinical documents may be free-text documents, whereas other documents may be structured document. Such a structured document may be a document which is generated by a computer program, based on data the user has provided by filling in an electronic form. For example, the structured document may be an XML document. Structured documents may comprise free-text portions. Such a free-text portion may be regarded as a free-text document encapsulated within a structured document. Consequently, free-text portions of structured documents may be treated by the system as free-text documents. Each of the clinical documents contains a list of information items. The list of information items including strings of free text, such as phases, sentences, paragraphs, words, and the like. The information items of the clinical documents can be generated automatically and/or manually. For example, various clinical systems automatically generate information items from previous clinical documents, dictation of speech, and the like. As to the latter, user input devices 24 can be employed. In some embodiments, the clinical information system 12 include display devices 26 providing users a user interface within which to manually enter the information items and/or for displaying clinical documents. In one embodiment, the clinical documents are stored locally in the clinical information database 22. In another embodiment, the clinical documents are stored nationally or regionally in the clinical information database 22. Examples of patient information systems include, but are not limited to, electronic medical record systems, departmental systems, and the like.

The clinical support system 14 utilizes natural language processing and pattern recognition to detect and visualize finding-specific suggestions and enable radiologists to navigate to the pertinent evidences relating to the finding-specific suggestions. The clinical support system 14 also provides patient context information and indicates the certainty/fidelity and relevance of the patient context information. Specifically, the clinical support system 14 processes the clinical documents to detected information items which include pre-defined pertinent clinical findings and information. The clinical support system 14 extracts information items including the pertinent clinical findings and information as well as the context of the extracted clinical findings and information from the clinical documents.

The information items including the pertinent clinical findings and information are processed to determine whether the information items contain any finding-specific suggestions. The clinical support system 14 further utilizes classification rules or guidelines to determine whether any finding-specific suggestions should be monitored that were not suggested by the previous radiologist. In addition, the clinical support system 14 determines the trustworthiness of and whether any information items containing pertinent clinical findings and information are similar or clinically relevant. To present finding-specific suggestions, the clinical support system 14 generates a user interface that enables the user to display detected finding-specific suggestions and to navigate to original reports containing the suggestions. The user interface also displays any trustworthy and clinical relevant patient context information referenced within the clinical documents. The clinical support system 14 includes a display 44 such as a CRT display, a liquid crystal display, a light emitting diode display, to display the information items and user interface and a user input device 46 such as a keyboard and a mouse, for the clinician to input and/or modify the provided information items.

Specifically, the clinical support system 14 includes a natural language processing engine 30 which processes the clinical documents to detect information items in the clinical documents and to detect a pre-defined list of pertinent clinical findings and information. To accomplish this, the natural language processing engine 30 segments the clinical documents into information items including sections, paragraphs, sentences, words, and the like. Typically, clinical documents contain a time-stamped header with protocol information in addition to clinical history, techniques, comparison, findings, impression section headers, and the like. The content of sections can be easily detected using a predefined list of section headers and text matching techniques. Alternatively, third party software methods can be used, such as MedLEE. For example, if a list of pre-defined terms is given (“lung nodule”), string matching techniques can be used to detect if one of the terms is present in a given information item. The string matching techniques can be further enhanced to account for morphological and lexical variant (Lung nodule =lung nodules =lung nodule) and for terms that are spread over the information item (nodules in the lung =lung nodule). If the pre-defined list of terms contains ontology IDs, concept extraction methods can be used to extract concepts from a given information item. The IDs refer to concepts in a background ontology, such as SNOMED or RadLex. For concept extraction, third-party solutions can be leveraged, such as MetaMap. Further, natural language processing techniques are known in the art per se. It is possible to apply techniques such as template matching, and identification of instances of concepts, that are defined in ontologies, and relations between the instances of the concepts, to build a network of instances of semantic concepts and their relationships, as expressed by the free text.

The clinical support system 14 also includes a context extraction engine 32 that extracts clinical findings and information such as diagnoses, clinical signs, symptoms, etc., and the context of the extracted clinical findings and information. For example, in the case of structured lab data, the context extraction engine 32 extracts the lab test results including the type of the test (white blood count), the range, date of the test and actual value of the test. In the case of EMR data, the context extraction engine 32 retrieves problem lists, if available, as active diagnosis and uses the below-described process to extract both additional clinical signs and symptoms and diagnosis from narrative data in the patient EMR record. Specifically, the context extraction engine 32 extracts clinical findings and information from the clinical documents and maps the clinical findings and information onto a structured data type that records the following information for each item of clinical information extracted: narrative context, i.e., the sentence and paragraph in which the item was found; the type of the document from which the item was extracted; the date of the document from which the item was extracted; and the section from which the item was extracted (conclusion/findings/clinical history). To accomplish this, the context extraction engine 32 utilizes existing natural language processing algorithms like MedLEE or MetaMap to extract clinical findings and information. Additionally, the context extraction engine 32 can utilize user-defined rules to extract certain types of findings that may appear in the document. Further, the context extraction engine 32 can utilize the study type of the current study and the clinical pathway, which defines required clinical information to rule in/out diagnosis, to check the availability of the required clinical information in the present document. Further extensions of the context extraction engine 32 allow for deriving the context meta-data for a given piece of clinical information. For example, in one embodiment, the context extraction engine 32 derives the clinical nature of the information item. A background ontology, such as SNOMED and RadLex, can be used to determine if the information item is a diagnosis or symptom. Home-grown or third-party solutions (MetaMap) can be used to map an information item to an ontology. In another embodiment, the context extraction engine 32 derives a standardized certainty level of the clinical finding or information. The context extraction engine 32 maps the clinical finding or information on a certainty scale depending on its narrative context. Such a scale might contain five values: absent, unlikely, possible, likely, present. The context extraction engine 32 can also use a list of keywords and known negation detection techniques (NegEx). For instance, “no prostate cancer” would be mapped to absent; and “evaluate for prostate cancer” would be mapped to “possible”. In another embodiment, the context extraction engine 32 derives the cross-disciplinary confirmation of the clinical finding or information. For example, if a diagnosis is found in two separate documents from two disciplines, this increases its certainty, e.g., pathologically confirmed diagnoses posited in a radiology report. In a further embodiment, the context extraction engine 32 can derive the normal range for numerical information, such as lab values and a Boolean indicating if the value is in the normal range.

The clinical support system 14 also includes a radiology-pathology classification engine 34 that determines whether an information item contains radiology-pathology specific suggestions using the content and the context of the information item. Specifically, the radiology-pathology classification engine 34 characterizes each candidate information item by means of one or more radiology-pathology features. A feature can be binary (yes/no), or numerical or an item from a controlled list. Given the nature of the problem, a logical approach is to detect keywords in the information item and characterize the information item by a series of binary features, each indicating if a certain keyword was found in the information item. The keywords can also be grouped together to form one feature. The radiology-pathology classification engine 34 then determines which information items contain a radiology-pathology specific recommendation using the characterization. To accomplish this, the radiology-pathology classification engine 34 utilizes a pre-defined list of pertinent radiology-pathology findings. In another embodiment, the radiology-pathology classification engine 34 utilizes a set of rules, or using statistical methods optimized with respect to a set of learning data. For example, the rules determine which information items contain radiology-pathology findings that should be monitored according to clinical guidelines but were not suggested by previous radiologists. Specifically, the radiology-pathology classification engine 34 executes one or more rules that reflect best practice/established guidelines. These rules may overrule the radiology-pathology classification engine 34 in case the latter indicates that the sentence contains no pertinent recommendations. For example, according to guidelines, sub-centimeter lung nodules need to be followed up. In the presence of such findings without explicit suggestions for surveillance, the radiology-pathology classification engine 34 treats such information items as ones with finding-specific suggestions.

Similar to the radiology-pathology classification engine 34, a radiology-lab/EMR data classification engine 36 of the clinical support system 14 determines whether an information item contains finding radiology-lab/EMR specific suggestions using the content and the context of the information item. Specifically, the radiology-lab/EMR data classification engine 36 characterizes each candidate information item by means of one or more radiology-lab/EMR data features. The radiology-lab/EMR data classification engine 36 determines which information items contain a radiology-lab/EMR data specific recommendation using the characterization. To accomplish this, the radiology-lab/EMR data classification engine 36 utilizes a pre-defined list of pertinent radiology-lab/EMR data findings. In another embodiment, the radiology-lab/EMR data classification engine 36 utilizes a set of rules, or using statistical methods optimized with respect to a set of learning data. Specifically, the radiology-lab/EMR data classification engine 36 executes one or more rules that reflect best practice/established guidelines. These rules may overrule the radiology-lab/EMR data classification engine 36 in case the latter indicates that the sentence contains no pertinent recommendations.

The clinical support system 14 also includes a trustfulness and relevance reasoning engine 38 that determines whether the determined suggestions are similar or clinically relevant. The trustfulness and relevance reasoning engine 38 also determines the trustfulness and relevance of each pertinent information item based on its meta-information. For example, if multiple suggestions were made on the same finding in the same or in multiple reports, the most recent one is selected by trustfulness and relevance reasoning engine 38 for the presentation to user. Context information about the suggestion, for example, when it was suggested the first time, how many times it was suggested, can also be extracted by the trustfulness and relevance reasoning engine 38 and included in the presentation. If the suggestion was made several years ago, the suggestion is considered by the trustfulness and relevance reasoning engine 38 to be less relevant. The threshold to determine whether a suggestion is too old to be relevant can be pre-set or dynamically adjusted by the trustfulness and relevance reasoning engine 38, depending on the nature of the findings. With regard to determining the trustfulness and relevancy of each information item, trustfulness and relevance reasoning engine 38 utilizes a set of rules or logic. For example, in terms of diagnoses findings, such rules may reflect the following logic: diagnoses extracted from the final diagnosis section of a pathology report have highest certainty/relevance; diagnoses extracted from a radiology report without pathological confirmation have less certainty and relevance; and diagnoses extracted from a radiology report without pathological confirmation and presented as hypothesis in the original document have the least certainty and relevance. The trustfulness and relevance reasoning engine 38 can also contain logic to always include certain types of diagnoses as high relevance (e.g. presence of cancer, implants) or to include only information from the most recent relevant reports of the patient. The relevance can be determined using combinations of DICOM BodyPart and Modality, Study Code and Description, and Reason for Exam. In terms of lab data, the rules may reflect the following logic: lab results that are less than e.g. 7 days old (or a predefined threshold) and beyond the normal range, have high relevance and certainty; lab results that are less than e.g. 7 days old (or a predefined threshold) and within the normal range, have less relevance but high certainty; and lab results that are more than 7 days old (or a predefined threshold), have low certainty/relevance. In terms of clinical signs and symptoms, the rules may reflect the following logic: a symptom that was repeated mentioned in the past 6 months (or a predefined threshold) is considered to have high relevance; the clinical history section of a radiology report or an imaging order may contain results of lab tests, e.g. “elevated wbc”. In this case, lab test results have high certainty if they can be correlated with actual data in lab reports; and a symptom that is more than one year old has low certainty/relevance. In another embodiment, the trustfulness and relevance reasoning engine 38 determines which prior clinical document counts as the most recent relevant prior exam. For example, the trustfulness and relevance reasoning engine 38 determines the most recent relevant prior exam by analyzing the date, modality, anatomy, and other meta-data associated with the clinical document.

In another embodiment, the trustfulness and relevance reasoning engine 38 incorporates numerical and statistical methods that use one or more thresholds. In such an embodiment, the trustfulness and relevance reasoning engine 38 endows each information item (such as phrase, or concept extracted from a sentence, or sentence proper) with a relevance value. This relevance value may fall within a pre-defined interval, e.g., [0, 1]. The relevance value may further be dependent on other parameters, such as, notably, time.

The relevance of clinical findings and information deteriorates as time passes by. The rate by which this happens depends on the nature of the concept. For instance, as was described earlier, the concept fever becomes irrelevant after one month, whereas prostate cancer is still relevant after two years. The trustfulness and relevance reasoning engine 38 utilizes a relevance degradation model to account for this deterioration. In a linear relevance degradation model, each clinical finding or information is endowed with two parameters a and b. The relevance of a given concept at time point t is then equal to:

b−α(t−t₀)

where t₀ is the latest moment in time when the concept was found in a clinical document pertaining to the patient at hand. The trustfulness and relevance reasoning engine 38 also conceives of exponential or hyperbolic models. It is further conceivable that the constant b is fixed to 1, for each clinical finding or information at hand. The parameters a and b can be obtained from fitting a linear/exponential regression model on analyzing retrospective data. To this end, the trustfulness and relevance reasoning engine 38 extracts the clinical finding or information from all clinical history sections of radiology reports, for instance. Then for each patient that owns a radiology report from which the clinical finding or information is extracted, the trustfulness and relevance reasoning engine 38 determines the oldest report in which it appeared. The trustfulness and relevance reasoning engine 38 then checks each consecutive clinical document if it contains the same clinical finding or information. If the clinical finding or information fever appears at some point, it will no longer appear in reports that are more than two months old, say, unless the patient represents with fever again. Large numbers of data will filter out the latter effect. By aggregating these data points for all patients a degradation ratio can be computed, which would correspond to the parameter a in the above equation.

The clinical support system 14 also includes a recommendation detection engine 42. The recommendation detection engine 42 characterizes each candidate information item by means of features. A feature can be binary (yes/no), or numerical or an item from a controlled list. The features can also be grouped together to form one feature. For instance, the recommendation detection engine 42 contains a feather that tells whether the sentence (or its successor/precursor) contains lesion keywords like “lesion”, “nodule”, “mass”, “foci”, “density”. The recommendation detection engine 42 contains a feature that tells whether the sentence contains suggestion keywords like “attention”, “monitor”, “surveillance”. The recommendation detection engine 42 contains a feature that tells if the information item expresses certain levels of concerns like “worrisome”, “however”, “special”; and if it contains negations “not”, “nor”, etc. The recommendation detection engine 42 determines which information items contain a finding-specific recommendation using a set of rules, or using machine-learning methods. The recommendation detection engine 42 further rule in information items that contain findings that should be monitored according to guidelines but were not suggested by previous radiologists. For instance, according to guidelines, sub-centimeter lung nodules need to be followed up. In the presence of such findings without explicit suggestions for surveillance, the rule engine treats such sentences as ones with finding-specific suggestions. The recommendation detection engine 42 can further filter out recommendations that are duplicates if the same recommendation appears in multiple clinical documents or the suggestion was made several years ago.

The clinical support system 14 also includes a clinical interface engine 34 that generates a user interface that enables the user to view detected finding-specific suggestions and navigate to original reports containing the suggestions. The user interface generated by the clinical interface engine 34 also displays the above mentioned context information of the patient. The patient context information can be presented in a summary view with relevance and certainty indicators. For example, the patient context information are sorted based on relevance, high relevant ones on the top of the list and less relevant ones in the bottom of the list. Information with high certainty is colored in green for instance and that with low certainty are colored differently. Additionally, the user interface can present other types of information, for example, prior finding-specific suggestions and technical notes from technologists who acquire the current imaging study.

The clinical interface system 16 displays the user interface that enables the user to view the detected finding-specific suggestions and patient context information as well navigate to original reports containing the suggestions. The clinical interface system 16 receives the user interface and displays the view to the caregiver on a display 48. The clinical interface system 16 also includes a user input device 50 such as a touch screen or keyboard and a mouse, for the clinician to input and/or modify the user interface views. Examples of caregiver interface system include, but are not limited to, personal data assistant (PDA), cellular smartphones, personal computers, or the like.

The components of the IT infrastructure 10 suitably include processors 60 executing computer executable instructions embodying the foregoing functionality, where the computer executable instructions are stored on memories 62 associated with the processors 60. It is, however, contemplated that at least some of the foregoing functionality can be implemented in hardware without the use of processors. For example, analog circuitry can be employed. Further, the components of the IT infrastructure 10 include communication units 64 providing the processors 60 an interface from which to communicate over the communications network 20. Even more, although the foregoing components of the IT infrastructure 10 were discretely described, it is to be appreciated that the components can be combined.

With reference to FIG. 2, a flowchart diagram of the operation of the IT infrastructure is illustrated. Although each of the blocks in the diagram is described sequentially in a logical order, it is not to be assumed that the system processes the described information in any particular order or arrangement. One or more clinical documents including radiology reports, pathology reports, lab reports, EMR data, and the like are stored in a clinical information database 12 of a clinical information system 22. A natural language processing engine 30 processes the clinical documents to detect information items in the clinical documents and to detect a pre-defined list of pertinent clinical findings and information. A context extraction engine 32 extracts clinical findings and information and the context of the extracted clinical findings and information from the clinical documents processed by the natural language processing engine 30. A radiology-pathology classification engine 34 determines whether an information item of the processed clinical documents contains finding radiology-pathology specific suggestions using the content and the context of the information items. A radiology-lab/EMR data classification engine 36 determines whether an information item of the processed clinical documents contains finding radiology-lab/EMR specific suggestions using the content and the context of the information items. To accomplish this, the radiology-pathology classification engine 34 and radiology-lab/EMR data classification engine 36 utilize a set of classification rules or logic 62 as described above to detect the specific suggestions. A trustfulness and relevance reasoning engine 38 determines the trustfulness and relevance of each clinical finding or information and/or specific suggestion. To determine the trustfulness and relevance of each clinical finding or information and/or specific suggestion, the trustfulness and relevance reasoning engine 38 utilizes a set of trustfulness and relevance rules or logic 64 as described above. A clinical interface engine 40 generates a user interface that allows the user to display detected finding-specific suggestions, patient context information, and navigate to original reports containing the specific suggestions.

With reference to FIG. 3, an exemplary embodiment of clinical context interface 100 generated by clinical support system is illustrated. The interface 100 enables the user to view detected relevant and trustworthy clinical findings and information associated with a patient and navigate to original reports containing the clinical findings and information in a single display. The interface 100 includes a summary 102 of the clinical findings and information which were detected by the clinical support system in the clinical documents. The summary 102 of clinical findings and information includes a pathology confirmed section 104 which provides confirmed pathology findings. A critical findings section 106 includes a list of critical findings which were detected in the clinical documents. The summary 102 of clinical findings and information also provides a past twelve month summary portion 108 which provide a summary of relevant clinical findings and information within the last year. A reason for exam section 110 indicates the reason for the patient's most recent exam. The clinical context interface 100 also includes a clinical document section 112 which displays the clinical document in which a specific clinical finding or information is located. For example, if the user were to click the possible pneumonia finding, the clinical support system would provide the clinical document in which the possible pneumonia finding was located. The interface 100 also includes a recommendations tab 114 which provides recommended actions based on the clinical findings and information as well as a history tab 116 which provides the complete clinical history of the patient.

With reference to FIG. 4, another exemplary embodiment of clinical context interface 200 generated by clinical support system is illustrated. The interface 200 includes a recommendation section 202 which provides the finding-specific suggestions which are detected by the clinical support system. The recommendation section 202 includes the finding-specification suggestions 204 which are detected in the clinical documents. For example, the highlighted suggestion 206 is from a 2011 XP Port Chest Exam in which it was suggested that a CT of the chest is recommended for further evaluation. The clinical context interface 100 also includes a clinical document section 208 which displays the clinical document in which a finding-specific suggestion is located. For example, if the user were to click the possible highlighted section 206, the clinical support system would provide the clinical document in which the possible finding-specific suggestion was located.

With reference to FIG. 5, a flowchart diagram 300 of a method for iterative construction of clinical histories is illustrated. Although each of the blocks in the diagram is described sequentially in a logical order, it is not to be assumed that the system processes the described information in any particular order or arrangement. In a step 302, one or more clinical documents are stored, each document including clinical data. In a step 304, the clinical documents are processed to detected clinical data pertinent to a patient. In a step 306, clinical findings from the clinical data and detects finding-specific suggestions are extracted from the clinical findings. In a step 308, a user interface is generated which enables the user to view the detected finding-specific suggestions.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an

Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for detecting and visualizing pertinent information and finding-specific suggestion, the system comprising:
a clinical database storing one or more clinical documents including clinical data;
a natural language processing engine which processes the clinical documents to detected clinical data pertinent to a patient;
a context extraction and classification engine which extracts clinical findings from the clinical data and detects finding-specific suggestions from the clinical findings; and
a clinical interface engine which generates a user interface which enables the user to view the detected finding-specific suggestions.

2. The system according to claim 1, wherein the context extraction and classification engine further extracts the context of the clinical data pertinent to a patient.

3. The system according to either one of claims 1 and 2, further including:
a trustfulness and relevance reasoning engine which determine whether the clinical data and/or finding specific suggestions are trustful and relevant.

4. The system according to any one of claim 1-3, wherein the trustfulness and relevance reasoning engine bases the trustfulness and relevancy of the clinical data and/or finding specific suggestions on the source of clinical data.

5. The system according to any one of claim 1-4, wherein the trustfulness and relevance reasoning engine bases the trustfulness and relevancy of the clinical data and/or finding specific suggestions on the time since the clinical data was created and the clinical context of the data.

6. The system according to any one of claims 1-5, wherein the user interface enables the user to navigate to the pertinent clinical documents which include the finding-specific suggestions.

7. The system according to any one of claims 1-6, wherein the context extraction and classification engine further determines whether any finding-specific suggestions were not suggest by a radiologist.

8. A system for detecting and visualizing pertinent information and finding-specific suggestion, the system comprising:
one or more processors programmed to:
store one or more clinical documents including clinical data;
process the clinical documents to detected clinical data pertinent to a patient;
extract clinical findings from the clinical data and detects finding-specific suggestions from the clinical findings; and
generate a user interface which enables the user to view the detected finding-specific suggestions.

9. The system according to claim 8, wherein the one or more processor are further programmed to:
extract the context of the clinical data pertinent to a patient.

10. The system according to either one of claims 8 and 9, wherein the one or more processor are further programmed to:
determine whether the clinical data and/or finding specific suggestions are trustful and relevant.

11. The system according to any one of claim 8-10, wherein the trustfulness and relevancy of the clinical data and/or finding specific suggestions is based on the time since the clinical data was created and the clinical context of the data.

12. The system according to any one of claims 8-11, wherein the trustfulness and relevance reasoning engine bases the trustfulness and relevancy of the clinical data and/or finding specific suggestions on the source of clinical data.

13. The system according to any one of claims 8-12, wherein the user interface enables the user to navigate to the pertinent clinical documents which include the finding-specific suggestions.

14. The system according to any one of claims 8-13, wherein the one or more processor are further programmed to:
determine whether any finding-specific suggestions were not suggest by a radiologist.

15. A method detecting and visualizing pertinent information and finding-specific suggestion, the method comprising:
storing one or more clinical documents, each document including clinical data;
processing the clinical documents to detected clinical data pertinent to a patient;
extracting clinical findings from the clinical data and detects finding-specific suggestions from the clinical findings; and
generating a user interface which enables the user to view the detected finding-specific suggestions.

16. The method according to claim 15, further including:
extracting the context of the clinical data pertinent to a patient.

17. The method according to either one of claims 15 and 16, further including:
determining whether the clinical data and/or finding specific suggestions are trustful and relevant.

18. The method according to any one of claim 15-17, wherein the trustfulness and relevancy of the clinical data and/or finding specific suggestions is based on the time since the clinical data was created and the clinical context of the data.

19. The method according to any one of claims 15-18, wherein the user interface enables the user to navigate to the pertinent clinical documents which include the finding-specific suggestions

20. The method according to any one of claims 15-19, further including:
determining whether any finding-specific suggestions were not suggest by a radiologist.
